(19) United States
(12) Patent Application Publication
(10) Pub. No.: US 2011/0302138 A1
(43) Pub. Date: Dec. 8, 2011

(54) NETWORK AWARE STORAGE DEVICE

(76) Inventor: Paul Michael Cesario, Fort Collins, CO (US)

(21) Appl. No.: 13/202,208

(22) PCT Filed: Feb. 26, 2009
(86) PCT No.: PCT/US2009/035347

§ 371 Date: Aug. 18, 2011

(51) Int. Cl. G06F 12/16; G06F 15/16; G06F 17/30

(52) U.S. Cl. 707/640; 707/E17.007; 707/E17.005

(57) ABSTRACT

In one embodiment a network attached storage device comprises at least one input/output port, at least one storage media, and a network caching module to receive, in the network attached storage device, a backup request from a computing device communicatively coupled to the network attached storage device, wherein the backup request identifies at least a first file, determine, in the network attached storage device, whether the at least a first file associated with the backup request resides on a storage media in the network attached storage device; and in response to a determination that the at least a first file associated with the backup request resides on a storage media in the network attached storage device executes the backup request against the at least a first file associated with the backup request which reside on a storage media in the network attached storage device, and initiates a remote backup operation to a remote network-based storage device coupled to the network attached storage device.

### BACKGROUND

The term Network Attached Storage (NAS) refers to a dedicated data storage device(s) connected directly to a computer network to provide centralized data access and storage services to one or more network clients such as, e.g., a personal computer. In some circumstances it may be useful to back up data residing on the one or more network clients to a network attached storage device.

### BRIEF DESCRIPTION OF THE DRAWINGS

FIG. 1 is a schematic illustration of one embodiment of network attached storage environment.

FIG. 2 is a schematic illustration of an exemplary network attached storage device.

FIGS. 3-4 are flowcharts illustrating operations in an embodiment of method to implement a backup operation in a network aware storage device.

FIGS. 5-6 are flowcharts illustrating operations in an embodiment of method to implement a data retrieval operation in a network aware storage device.

### DETAILED DESCRIPTION

Described herein are exemplary systems and methods to implement a network aware storage device. The methods described herein may be embodied as logic instructions stored on a computer-readable medium. When executed on a processor, the logic instructions cause a general processor to be programmed as a special-purpose machine that implements the described methods. The processor, when configured by the logic instructions to execute the methods recited herein, constitutes structure for performing the described methods.

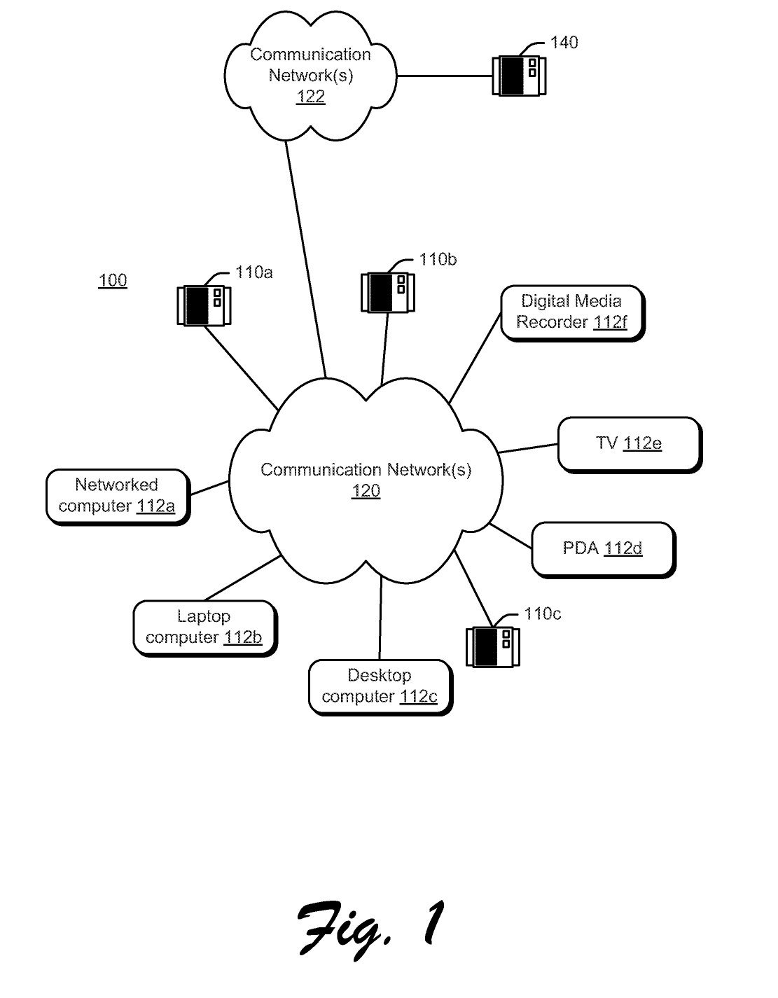

FIG. 1 is a schematic illustration of one embodiment of network attached storage environment in which a secure media system may be implemented. Environment 100 may comprise one or more network attached storage devices 110a, 110b, 110c connected to one or more network clients 112a, 112b, 112c, 112d, 112e, 112f by a communication network 120. Further, network attached storage devices 110a, 110b may be connected to a remote network-based storage device 140 via a communication network 122.

Network attached storage devices 110a, 110b, 110c may be implemented as one or more communicatively connected storage devices. Exemplary storage devices may comprise, but are not limited to, the Media Vault™ line of storage devices commercially available form Hewlett-Packard Corporation of Palo Alto, Calif., USA. In some embodiments, at least a portion of communication network 120 may be implemented as a private, dedicated network such as, e.g., a local area network (LAN) or a wide area network (WAN). Alternatively, portions of communication network 120 may be implemented using public communication networks such as, e.g., the Internet, pursuant to a suitable communication protocol such as, e.g. TCP/IP.

Network clients 112a, 112b, 112c, 112d, 112e, 112f may be implemented as computing devices such as, e.g., a networked computer 112a, a laptop computer 112b, a desktop computer 112c, a personal digital assistant (PDA) 112d, a smart phone 112e, other computing devices 112f or the like. Applications running on network clients 112a, 112b, 112c, 112d, 112e, 112f may initiate file access requests to access information stored in network attached storage devices 110a, 110b, 110c. Network attached storage devices 110a, 110b, 110c receive file access requests and, in response, locate and return the requested information to the network client that originated the request.

In some embodiments, a network attached storage device such as device 110a or 110b may function as a media server. Media files such as, for example, music or video files, may be stored on the network attached storage device. One or more of client devices 112a, 112b, 112c, 112d, 112e, 112f, may initiate a request for media content from a network attached storage device. In response, the network attached storage device can either transmit a copy of the media file to the requesting client or may initiate a playback routine to play the media file to the requesting client device. In such embodiments, users of the network attached storage device may choose to load copyrighted works from a storage media (e.g., a compact disc, a digital video disc, or the like) onto the network attached storage device.

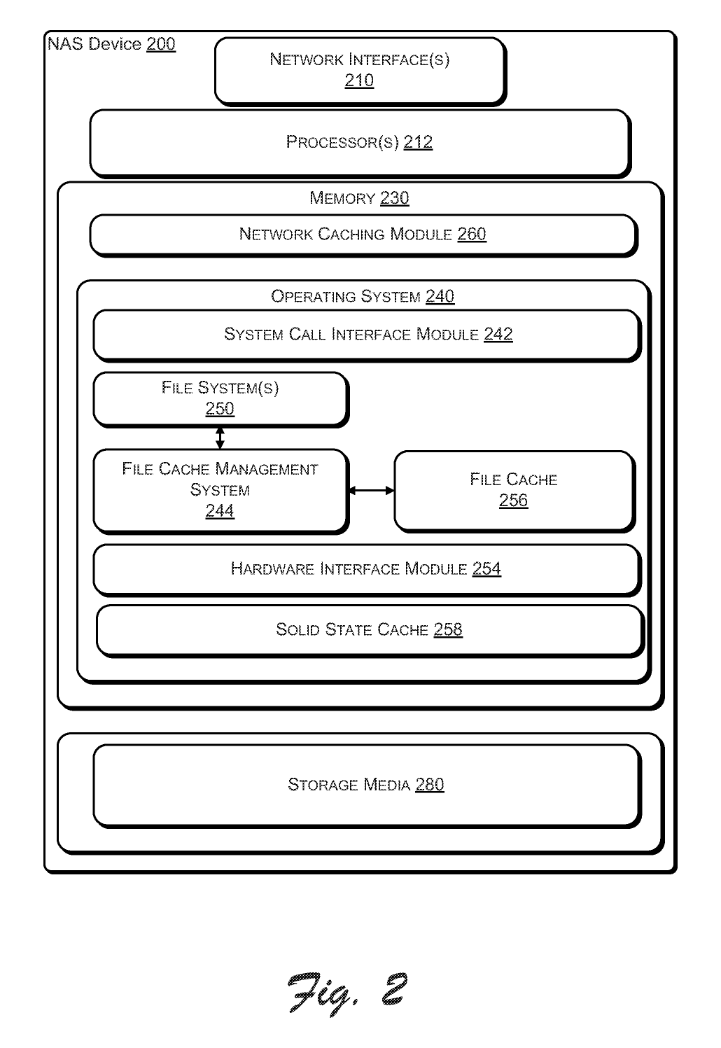

FIG. 2 is a schematic illustration of one embodiment of a network attached storage (NAS) device 200, which may be used to implement one or more of network attached storage devices 110a, 110b, 110c depicted in FIG. 1. Referring to FIG. 2, network storage device 200 comprises one or more network interfaces 210 which enables a communication connection with a network such as, e.g., network 120.

Network interface 210 may comprise an input/output (I/O) port to provide a physical connection with a network. For example, network interface 210 may comprise an Ethernet port. Network interface 210 may comprise a network interface card (NIC), also commonly referred to as a network adapter or a network card. The NIC manages I/O operations to enable NAS device 200 to communicate over a network. Alternatively, the operations of the NIC may be implemented on a main circuit board such as, e.g., a motherboard of NAS device 200.

NAS device 200 further comprises at least one processor 212. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

NAS device 200 further comprises system random access memory and/or read-only memory 230. Memory 230 comprises an operating system 240 for managing operations of NAS device 200. In one embodiment, operating system 240 comprises a hardware interface module 254 that provides an interface to system hardware. The particular embodiment of operating system 240 is not critical to the subject matter described herein. Operating system 240 may be embodied as a UNIX operating system or any derivative thereof (e.g., Linux, Solaris, etc.) or as a Windows® brand operating system.

Operating system 240 comprises (or interfaces with) a file system(s) 250 that manages files used in the operation of NAS device 200. For example, file system(s) 250 may implement one or more file systems such as FAT, NTFS, ext3, reiser, or the like. In one embodiment, operating system 240 may comprise a file cache management system 244 interposed logically between the file system(s) 250 and underlying modules such as, e.g., the hardware interface module 254. File cache management system 244 interfaces with the file system(s) 250 to manage the file cache 256 as a resource that may be shared between users of the computer system, e.g., on a per-workload basis.

Operating system 240 further comprises a system call interface module 242 that provides an interface between the operating system 240 and one or more application modules that execute on NAS device 200.

NAS device 200 further comprises storage media 280. In some embodiments, NAS device 200 may be implemented as a network aware storage device which operates essentially as a local caching device, yet relies on network-bases storage for longer-term storage needs. In such embodiments, storage media 280 may be embodied as one or more magnetic disk drives. Alternatively, NAS device 200 may rely on solid state cache 258 as a cache memory device. Still alternatively, storage media 280 may comprise optical, magneto-optical, or electro-optical storage media.

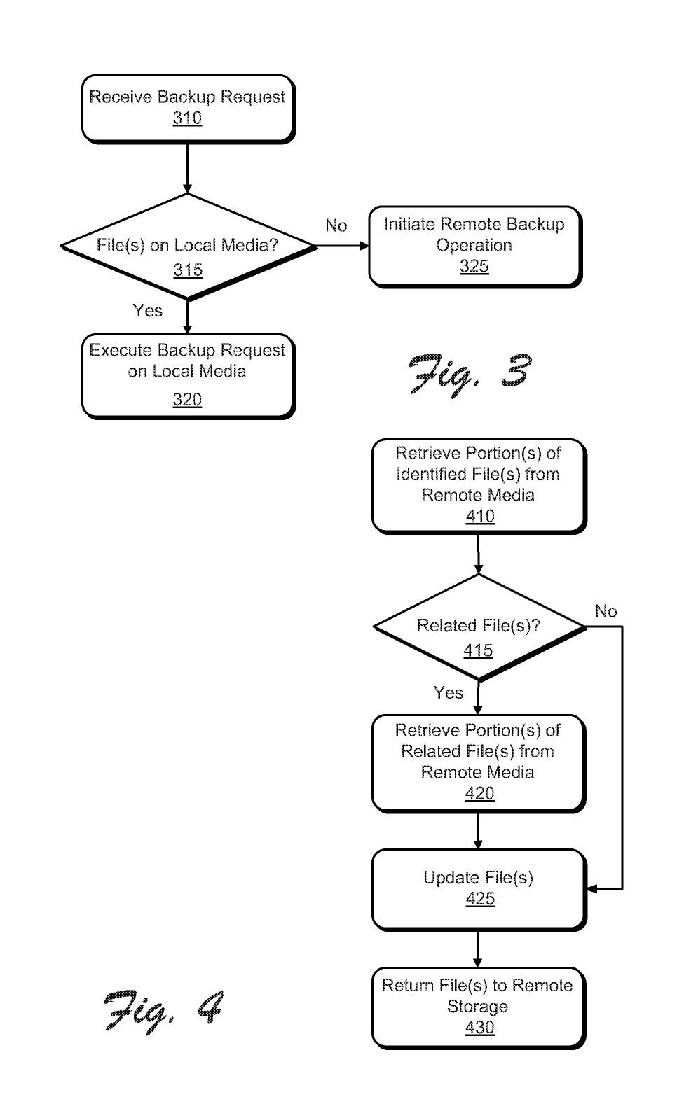

NAS device 200 further comprises a network caching module 260. In some embodiments, a network caching module 260 is embodied as a software module that executes on processor(s) 212. By way of example and not limitation, a network caching module 260 may receive and process backup requests and data retrieval requests from clients of NAS device 200. Operations implemented by some embodiments of network caching module 260, are described with reference to FIGS. 3-4 and FIGS. 5-6.

FIGS. 3-4 are flowcharts illustrating operations in an embodiment of method to implement a backup operation in a network aware storage device. In some embodiments, the operations depicted in FIGS. 3-4 are implemented by the network caching module 260.

Referring to FIG. 3, at operation 310, a network attached storage device 200 may receive a backup request to backup one or more files being used by one or more computing devices that may have been added to the network. In some embodiments, the backup request includes an identifier associated with the one or more data files. By way of example and not limitation, the identifier may be the file name, code logically associated with the file name, or the like.

At operation 315 it is determined whether the file identified in the backup request resides on the local media, i.e., in the solid state cache 258 or in the storage media 280. If at operation 315, the file identified in the backup request resides on the local media, then control passes to operation 320 and the backup request is executed against the file(s) on the local media identified in the backup request. In some embodiments the backup request may include a portion of the file(s) identified in the backup request, and executing the backup request may comprise storing the backup request and the associated data in at least one of the solid state cache 258 or in the storage media 280.

By contrast, if at operation 315 the file(s) do not reside on the local media, then control passes to operation 325 and a remote backup operation is implemented. In some embodiments of a remote backup operation the NAS device 200 may forward the backup request to a remote network-based storage device such as device 140, which manages the backup operation external to the NAS device 200. In other embodiments, the NAS device my retrieve at least a portion of the file(s) identified in the search request and implement the update process within NAS device 200. FIG. 4 is a flowchart illustrating operations in such an embodiment.

Referring to FIG. 4, at operation 410 a portion(s) of the file identified in the backup request is retrieved from the remote network-based storage device 140 and stored in the memory of network attached storage device 200. In some embodiments, the NAS device 200 may maintain a table of related files stored on the remote storage device 140. If, at operation 415, there are files in the remote network-based storage device that are tagged as being related to the identified file(s) in the backup request, then at operation 420 the NAS device 200 retrieves at least a portion of the related file(s) from the remote network-based storage device 140. By contrast, if at operation 415 there are no files related to the file(s) identified in the backup request, then control passes to operation 425 and the file(s) identified in the backup request are updated with the data received in the backup request. At operation 430, the updated file(s) may be returned to the remote network-based storage device 140 for storage.

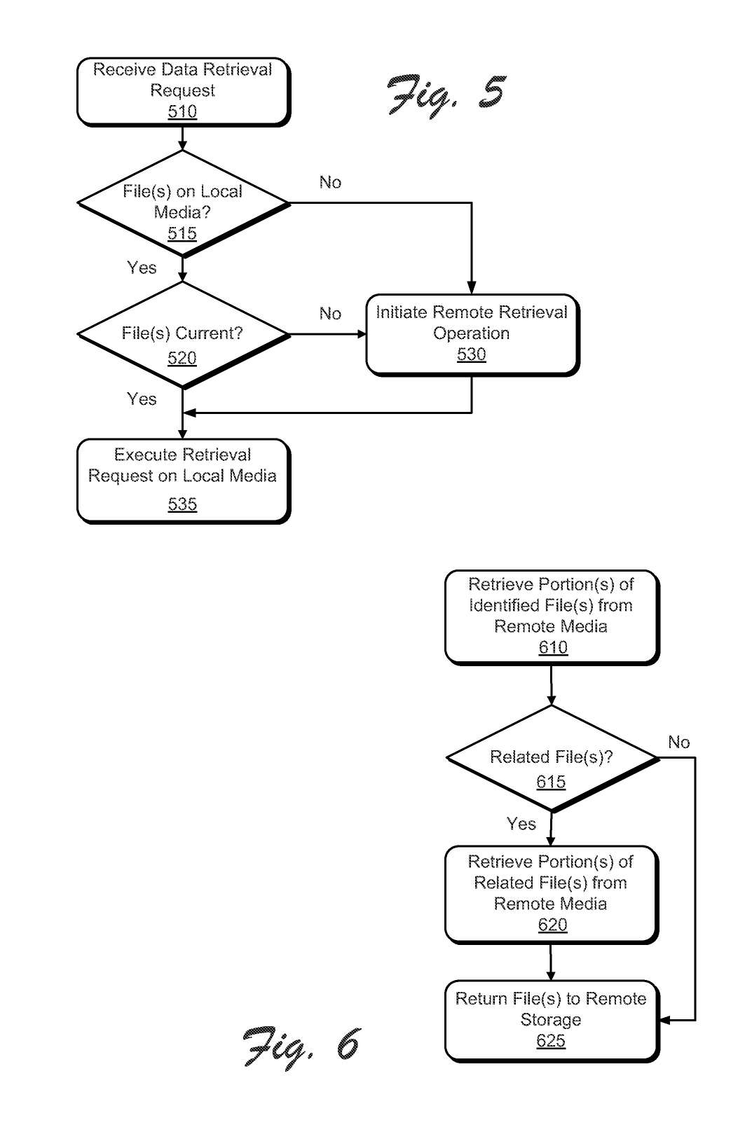

FIGS. 5-6 are flowcharts stating operations in an embodiment of method to implement a data retrieval operation in a network aware storage device. In some embodiments, the operations depicted in FIGS. 5-6 are implemented by the network caching module 260.

Referring to FIG. 5, at operation 510, a network attached storage device 200 may receive a data retrieval request to retrieve one or more files being used by one or more computing devices coupled to network attached storage device 200. In some embodiments, the data retrieval request includes an identifier associated with the one or more data files. By way of example and not limitation, the identifier may be the file name, code logically associated with the file name, or the like.

At operation 515 it is determined whether the file identified in the data retrieval request resides on the local media, i.e., in the solid state cache 258 or in the storage media 280. If at operation 515, the file identified in the backup request resides on the local media, then control passes to operation 520, where it is determined whether the file(s) identified in the data retriefval request are current. In some embodiments, the NAS device 200 may compare timestamps associated with the last update on the file(s) identified in the data retrieval request to determine whether the file(s) are current. Alternate embodiments may utilize a hash of timestamp, name, and file size to create an identifiable key to determine if the file matches. If, at operation 520, the file(s) identified in the data retrieval request are current, the control passes to operation 535 and the data retrieval request is executed against the file(s) on the local media identified in the backup request.

By contrast, if at operation 515 the file(s) do not reside on the local media, or if at operation 520 the files are not current, then control passes to operation 530 and a remote retrieval operation is implemented. Control then passes to operation 535 and the data retrieval request is executed against the file(s) on the local media identified in the backup request. In some embodiments of remote data retrieval operation the NAS device 200 may forward the data retrieval request to a remote network-based storage device such as device 140, which manages the data retrieval operation external to the NAS device 200. In other embodiments, the NAS device 200 may retrieve at least a portion of the file(s) identified in the data retrieval request.

Referring to FIG. 6, at operation 610 a portion(s) of the file identified in the data retrieval request is retrieved from the remote network-based storage device 140 and stored in the memory of network attached storage device 200. As described above, the NAS device 200 may maintain a table of related files stored on the remote storage device 140. If, at operation 615, there are files in the remote network-based storage device that are tagged as being related to the identified file(s) in the data retrieval request, then at operation 420 the NAS device 200 retrieves at least a portion of the related file(s) from the remote network-based storage device 140. By contrast, if at operation 615 there are no files related to the file(s) identified in the data retrieval request, then control passes to operation 625 and the file(s) identified in the data retrieval request are updated with the data received in the backup request. At operation 430, the updated file(s) may be returned to the remote network-based storage device 140 for storage.

Thus, described herein are exemplary systems and methods to implement a network a network aware storage device. According to the principles described, a NAS device may be constructed using a relatively small amount of local storage, but may provide virtually unlimited storage by using network-based storage techniques. Some embodiments may be provided as computer program products, which may comprise a machine-readable or computer-readable medium having stored thereon instructions used to program a computer (or other electronic devices) to perform a process discussed herein. The machine-readable medium may comprise, but is not limited to, floppy diskettes, hard disk, optical disks, CD-ROMs, magneto-optical disks, ROMs, RAMs, erasable programmable ROMs (EPROMs), electrically erasable EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Reference in the specification to “one embodiment” or “an embodiment” means that a particular feature, structure, or characteristic described in connection with the embodiment is comprised in at least an implementation. The appearances of the phrase “in one embodiment” in various places in the specification are not necessarily all referring to the same embodiment.

What is claimed is:

1. A method to manage backup operations in a network attached storage device, comprising:
receiving, in the network attached storage device, a backup request from a computing device communicatively coupled to the network attached storage device, wherein the backup request identifies at least a first file;
determining, in the network attached storage device, whether the at least a first file associated with the backup request resides on a storage media in the network attached storage device; and
in response to a determination that the at least a first file associated with the backup request resides on a storage media in the network attached storage device:
executing the backup request against the at least a first file associated with the backup request which reside on a storage media in the network attached storage device; and
initiating a remote backup operation to a remote network-based storage device coupled to the network attached storage device.

2. The method of claim 1, wherein executing the backup request against the at least a first file associated with the backup request which reside on a storage media in the network attached storage device comprises storing the input/output request and associated data in at least one of a solid state cache memory or a hard disk drive.

3. The method of claim 1, wherein in response to a determination that the at least a first file associated with the backup request does not reside on a storage media in the network attached storage device:
retrieving at least a portion of the at least a first file associated with the backup request from the remote network-based storage device;
executing the backup request against the at least one portion of the at least a first file retrieved from the remote network-based storage device; and
returning the updated at least a portion of the at least a first file associated with the backup request to the remote network-based storage device.

4. The method of claim 1, wherein in response to a determination that the at least a first file associated with the backup request do not reside on a storage media in the network attached storage device:
storing in cache memory the backup request from the remote network-based storage device;
initiating a remote backup operation to a remote network-based storage device coupled to the network attached storage device; and
deleting the backup request from cache memory in response to a message from the remote network-based storage device.

5. The method of claim 1, further comprising:
identifying, in the network attached storage devices, at least a second file tagged as related to the at least a first file; and
retrieving at least a portion of the at least a second file from the remote network-based storage device; and
storing the at least a portion of the at least a second file from the remote network-based storage device in memory in the network attached storage device.

6. A network attached storage device, comprising:
at least one input/output port;
at least one storage media;
at least one network caching module to:
receive, in the network attached storage device, a backup request from a computing device communicatively coupled to the network attached storage device, wherein the backup request identifies at least a first file;
determine, in the network attached storage device, whether the at least a first file associated with the backup request resides on a storage media in the network attached storage device; and
in response to a determination that the at least a first file associated with the backup request resides on a storage media in the network attached storage device:
executes the backup request against the at least a first file associated with the backup request which reside on a storage media in the network attached storage device; and
initiates a remote backup operation to a remote network-based storage device coupled to the network attached storage device.

7. The network attached storage device of claim 6, wherein the network caching module stores the input/output request and associated data in at least one of a solid state cache memory or a hard disk drive.

8. The network attached storage device of claim 6, wherein the network caching module:
retrieves at least a portion of the at least a first file associated with the backup request from the remote network-based storage device;
executes the backup request against the at least one portion of the at least a first file retrieved from the remote network-based storage device; and
returns the updated at least a portion of the at least a first file associated with the backup request to the remote network-based storage device.

9. The network attached storage device of claim 15, wherein the network caching module
stores in cache memory the backup request from the remote network-based storage device;
initiates a remote backup operation to a remote network-based storage device coupled to the network attached storage device; and
deletes the backup request from cache memory in response to a message from the remote network-based storage device.

10. The network attached storage device of claim 15, wherein the device backup module:
identifies, in the network attached storage devices, at least a second file tagged as related to the at least a first file; and
retrieves at least a portion of the at least a second file from the remote network-based storage device; and
stores the at least a portion of the at least a second file from the remote network-based storage device in memory in the network attached storage device.

11. A method to manage data retrieval operations in a network attached storage device, comprising:
receiving, in the network attached storage device, a data retrieval request from a computing device communicatively coupled to the network attached storage device, wherein the data retrieval request identifies at least a portion of a first file;
determining, in the network attached storage device, whether the at least a portion of a first file associated with the data retrieval request resides on a storage media in the network attached storage device; and
in response to a determination that the at least a portion of the first file associated with the data retrieval request resides on a storage media in the network attached storage device:
initiating a status check operation in the network attached storage device to determine whether the at least a portion of a first file is current; and
in response to a determination that the at least a portion of the first file is current, executing the data retrieval request against the at least a portion of the first the in the network attached storage device.

12. The method of claim 11, initiating a status check operation in the network attached storage device to determine whether the at least a portion of a first file is current comprises comparing a timestamp associated with the at least a portion of a first file on the network attached storage device with a timestamp on a corresponding file on a remote network-based storage device coupled to the network attached storage device.

13. The method of claim 11, wherein in response to a determination that the at least a portion of the first file associated with the data retrieval request does not reside on a storage media in the network attached storage device:
retrieving the at least a portion of the first file associated with the backup request from the remote network-based storage device;
executing the data retrieval request against the at least a portion of the first file retrieved from the remote network-based storage device.

14. The method of claim 11, wherein in response to a determination that the at least a first file associated with the backup request do not reside on a storage media in the network attached storage device:
identifies, in the network attached storage devices, at least a second file tagged as related to the at least a first file; and
retrieves at least a portion of the at least a second file from the remote network-based storage device; and
stores the at least a portion of the at least a second file from the remote network-based storage device in memory in the network attached storage device.

15. A network attached storage device, comprising:
at least one input/output port;
at least one storage media;
at least one network caching module to:
receive, in the network attached storage device, a data retrieval request from a computing device communicatively coupled to the network attached storage device, wherein the data retrieval request identifies at least a portion of a first file;
determine, in the network attached storage device, whether the at least a portion of a first file associated with the data retrieval request resides on a storage media in the network attached storage device; and
in response to a determination that the at least a portion of the first file associated with the data retrieval request resides on a storage media in the network attached storage device:
initiate a status check operation in the network attached storage device to determine whether the at least a portion of a first file is current; and
in response to a determination that the at least a portion of the first file is current, execute the data retrieval request against the at least a portion of the first file in the network attached storage device.

16. The network attached storage device of claim 15, wherein the network caching module compares a timestamp associated with the at least a portion of a first file on the network attached storage device with a timestamp on a corresponding file on a remote network-based storage device coupled to the network attached storage device.

17. The network attached storage device of claim 15, wherein in response to a determination that the at least a portion of the first file associated with the data retrieval request does not reside on a storage media in the network attached storage device:
retrieving the at least a portion of the first file associated with the backup request from the remote network-based storage device;
executing the data retrieval request against the at least a portion of the first file retrieved from the remote network-based storage device.

18. The network attached storage device of claim 15, wherein in response to a determination that the at least a first file associated with the data retrieval request do not reside on a storage media in the network attached storage device:
identifies, in the network attached storage devices, at least a second file tagged as related to the at least a first file; and
retrieves at least a portion of the at least a second file from the remote network-based storage device; and
stores the at least a portion of the at least a second file from the remote network-based storage device in memory in the network attached storage device.
